(19) United States
(12) Patent Application Publication
(10) Pub. No.: US 2013/0147940 A1
(43) Pub. Date: Jun. 13, 2013

(54) CELL COUNTER AND METHOD OF MANUFACTURING THE SAME

(71) Applicant: Logos Biosystems, Inc., Gyeonggi-do (KR)

(72) Inventors: Hyun Chang Lim, Seoul (KR); Neon Cheol Jung, Gyeonggi-do (KR); Keunchang Cho, Seoul (KR)

(73) Assignee: Logos Biosystems, Inc., Gyeonggi-do (KR)

(21) Appl. No.: 13/709,378

(22) Filed: Dec. 10, 2012

(30) Foreign Application Priority Data
Dec. 12, 2011 (KR) 10-2011-0132829

(51) Int. Cl. G02B 21/00; G02B 21/36

(52) U.S. Cl. CPC G02B 21/0004; G02B 21/361; G02B 21/365
USPC 348/79; 359/396; 359/385; 29/592

(57) ABSTRACT

A cell counter includes: a sample slide configured to accommodate cells; a housing configured to be inserted into the inside of the sample slide from the outside of the sample slide; an object lens configured to be mounted within the housing, and to image-form a cell image for the cells projected from the sample slide; an image acquisition unit configured to be mounted within the housing together with the object lens, and to acquire the cell image image-formed by the object lens; and a first reflecting mirror provided between the sample slide and the object lens within the housing, and configured to change a projection direction of the cell image projected from the sample slide to the object lens.

### FIELD OF THE INVENTION

The present invention relates to a cell counter and a method of manufacturing the same, and more particularly to a cell counter and a method manufacturing the same in which the cell counter has no technical limitation in height such that a user's convenience and esthetical sense may be taken into consideration and the cell counter may be advantageous in manufacturing other devices including such a cell counter, and that is capable of minimizing an effect by weight.

### DESCRIPTION OF THE PRIOR ART

Nowadays, as optics, and electric and electronic sciences are developed, information on cells (e.g., the number and specific shapes of cells) is automatically obtained using an equipment called a “cell counter” unlike in the past where the information on cells have been obtained visually through a microscope.

However, as illustrated in FIGS. 1 and 2, a conventional cell counter unavoidably has a relatively high height due to the relationship between the individual components of the cell counter. Thus, it is impossible to take a user's convenience and esthetic sense into consideration, and a considerable difficulty is caused in manufacturing other devices including such a cell counter.

That is, with the conventional cell counter, when a sample slide 30 configured to accommodate cells that have information the user desires to obtain is inserted horizontally (in the direction indicated by arrow denoted by “Ref” and referred to as “Ref arrow” below) into a housing that constitutes the outer appearance of the cell counter, the sample slide 30 is disposed between an object lens 40 and a collimating lens 20 which are vertically arranged (in a direction perpendicular to the direction by Ref arrow).

The cells in the sample slide 30 disposed in this manner produce a cell image through light provided from a light source 10 and adjusted through the collimating lens 20, and the cell image produced in this manner can be acquired through an image acquisition unit 50 only when the cell image is image-formed by the object lens 40. Accordingly, the object lens 40 and the collimating lens 20 should be unavoidably vertically disposed with reference to the sample slide 30.

Accordingly, there is a problem in that because the housing that constitutes the external appearance of the cell counter should be unavoidably subject to many limitations due to the object lens 40 and the collimating lens 20, it is difficult to take the user's convenience and esthetic sense into consideration, and causes a considerable difficulty in manufacturing other devices including such a cell counter.

Furthermore, there is an additional problem in that because the object lens 40 of the conventional cell counter is disposed in the height (vertical) direction within the housing that constitutes the cell counter, the object lens 40 may be finely moved downward under the influence of weight when it is used for a long period, which may cause in turn a previously set focus to be changed.

In order to solve these problems, another conventional cell counter having a product name, “Countess,” manufactured by Invitrogen is separately provided with an object lens fixing device. However, this cell counter cannot solve the above-mentioned problem caused by the height of the housing that constitutes the external appearance of the cell counter.

### SUMMARY OF THE INVENTION

### Technical Problem

Accordingly, the present invention has been made to solve the above-mentioned problems and an aspect of the present invention is to provide a cell counter and a method of manufacturing the same in which the cell counter has no technical limitation in height such that a user's convenience and esthetical sense can be taken into consideration and the cell counter can be advantageous in manufacturing other devices including such a cell counter, and the cell counter can be configured to minimize an effect by weight.

In addition, the technical problems to be solved by the present invention are not limited to the above-mentioned problems, and other technical problems not described above can be clearly understood by an ordinarily skilled in the art to which the present invention pertains from the description provided below.

### Technical Solution

In order to accomplish this, there is provided a cell counter including: a sample slide configured to accommodate cells; a housing configured to be inserted into the inside of the sample slide from the outside of the sample slide; an object lens configured to be mounted within the housing, and to image-form a cell image for the cells projected from the sample slide; an image acquisition unit configured to be mounted within the housing together with the object lens, and to acquire the cell image image-formed by the object lens; and a first reflecting mirror provided between the sample slide and the object lens within the housing, and configured to change a projection direction of the cell image projected from the sample slide to the object lens.

Here, the first reflecting mirror may be configured to change the projection direction of the object lens projected to the object lens in such a manner that the height of the housing is not limited by the arrangement of the object lens and the image acquisition unit.

In addition, the object lens and the image acquisition unit may be arranged on a virtual plane that is parallel to a virtual plane where the sample slide is arranged after being inserted into the inside of the housing. Due to this, the height of the housing may be 50 mm to 150 mm.

Meanwhile, the inventive cell counter may further includes: a light source configured to provide light toward the sample slide; a collimating lens configured to adjust the light provided from the light source; and a second reflecting mirror provided in a side opposite to the first reflecting mirror with reference to the sample slide to change the direction in which the light adjusted through the collimating lens is directed.

At this time, the second reflecting mirror may be configured to change the direction of the light directed toward the sample slide in such a manner that the height of the housing is not limited by the arrangement of the light source and the collimating lens.

In such a case, the object lens and the image acquisition unit arranged on a virtual plane within the housing which is parallel to a virtual plane where the sample slide is arranged after being inserted into the inside of the housing, and the light source and the collimating lens are arranged on the virtual plane within the housing which is parallel to the virtual plane where the object lens and the image acquisition unit are arranged. With this configuration, the housing may have a height of 50 mm to 150 mm.

Meanwhile, the inventive cell counter may further include a calculation unit configured to calculate cell information on the cells from the cell image acquired through the image acquisition unit; and a display unit configured to display the cell information calculated through the calculation unit.

Here, the display unit may be configured to display the cell information in a preset type when a pointing input unit is touched to the display unit. In addition, the display unit may be configured to be arranged on the top side of the housing.

Furthermore, the inventive cell counter may further include a storage unit configured to store all the cell information calculated through the calculation unit, and to separately store the cell information displayed on the display unit.

According to another aspect of the present invention, there is provided a cell counter including: a housing provided with a display unit on the outer top side thereof; a sample slide configured to accommodate cells and to be inserted into the inside of the housing from the outside of the housing in a direction parallel to the internal bottom side of the housing through a slide insertion hole provided in a lateral side of the housing; an object lens mounted in the inside of the housing to image-form a cell image for the cells which is projected from the sample slide, the object lens being arranged on the internal bottom side in a transversal or longitudinal direction of the housing in such a manner that an operation distance in which the object lens is operated to adjust the focus thereof when the cell image is image-formed does not restrain the height of the housing; and a first reflecting mirror provided between the sample slide and the object lens within the housing, and configured to change a direction of projecting the cell image so that the cell image can be projected from the sample slide to the object lens.

The inventive cell counter may further include: a light source configured to provide light toward the sample slide; a collimating lens mounted within the inside of the housing to adjust the light provided from the light source in such a manner that a contrast value of the cell image projected to the object lens can be adjusted, the collimating lens being arranged parallel to a virtual plane where the object lens is arranged in the transversal or longitudinal direction of the housing in such a manner that the distance from the light source does not restrain the height of the housing; and a second reflecting mirror provided in a side opposite to the first reflecting mirror with reference to the sample slide to change the direction in which the light adjusted through the collimating lens is directed.

In addition, the inventive cell counter may further include: an image acquisition unit configured to acquire the cell image image-formed by the object lens; and a calculation unit configured to calculate cell information on the cell from the cell image acquired through the image acquisition unit, wherein the image acquisition unit and the calculation unit are arranged on the virtual plane in the housing where the first reflecting mirror and the object lens are arranged so that the height of the housing can be 50 mm to 150 mm.

According to another aspect of the present invention, there is provided a method of manufacturing a cell counter, in which the method may manufacture the cell counter by arranging a first reflecting mirror configured to change a direction of projecting the sample image projected to the object lens between a sample slide and an object lens configured to image-form a cell image for cells accommodated in the sample slide, so that the height is not limited by an operating distance where the object lens is operated to adjust the focus thereof when image-forming the cell image.

At this time, the inventive method of manufacturing a cell counter may be characterized in that a light source configured to provide light toward the sample slide and a collimating lens configured to adjust the light provided from the light source may be additionally arranged on a virtual plane within the housing which is parallel to a virtual plane where the first reflecting mirror and the object lens are arranged within the housing, and a second reflecting mirror may be arranged in a side opposite to the first reflecting mirror with reference to the sample slide, so that the height of the housing is not limited by the distance from the light source to the collimating lens.

Furthermore, in such a case, the inventive method of manufacturing a cell counter may be characterized in that an image acquisition unit configured to acquire the image cell image-formed by the object lens and a calculation unit configured to calculate cell information on the cell from the cell image acquired through the image acquisition unit may be arranged on the virtual plane where the first reflecting mirror and the object lens are arranged within the housing so that the height of the housing can be 50 mm to 150 mm.

### Advantageous Effects

According to the inventive cell counter and the inventive method of manufacturing the same, the object lens and the collimating lens are arranged not to limit the height of the housing. Thus, there is an advantage in that it is possible to provide a cell counter having a height that allows a user's convenience and esthetic sense to be taken into consideration and is advantageous in manufacturing other devices including such a cell counter.

In addition, according to the inventive cell counter and the inventive method of manufacturing the same, the object lens and the collimating lens are arranged in the transversal or longitudinal direction of housing which is irrelevant to the height of the housing. Thus, there is an advantage in that it is possible to remove a difficulty to adjust again the previously set focus even if the cell counter has been used for a long period.

### BRIEF DESCRIPTION OF THE DRAWINGS

The above and other aspects, features and advantages of the present invention will be more apparent from the following detailed description taken in conjunction with the accompanying drawings, in which:

FIGS. 1 and 2 are schematic views for describing a conventional cell counter;

FIG. 3 is a schematic view for describing the inventive cell counter;

FIG. 4 is a cross-sectional view of a cell counter according to an exemplary embodiment of the present invention;

FIG. 5 is a perspective view of the cell counter according to the exemplary embodiment of the present invention;

FIG. 6 is a side view of the cell counter according to the exemplary embodiment of the present invention; and

FIGS. 7 and 8 are photographs illustrating examples of displaying information about cells through a display unit provided in the cell counter according to the exemplary embodiment of the present invention.

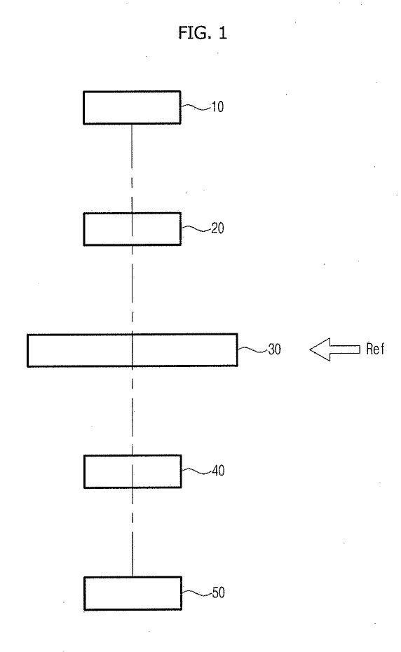

### DETAILED DESCRIPTION OF THE PREFERRED EMBODIMENTS

Hereinafter, an exemplary embodiment of the present invention will be described in detail with reference to accompanying drawings. However, already known functions or constructions may be omitted from the description of the present invention in order to make the gist of the present invention clear. In addition, the terms premising a direction, such as transversal, longitudinal, upper side, and lower side, are merely used in describing the exemplary embodiment of the present invention in order to help an ordinarily skilled in the art to easily understand the present invention. Of course, the terms are not intended to limit the scope of the present invention.

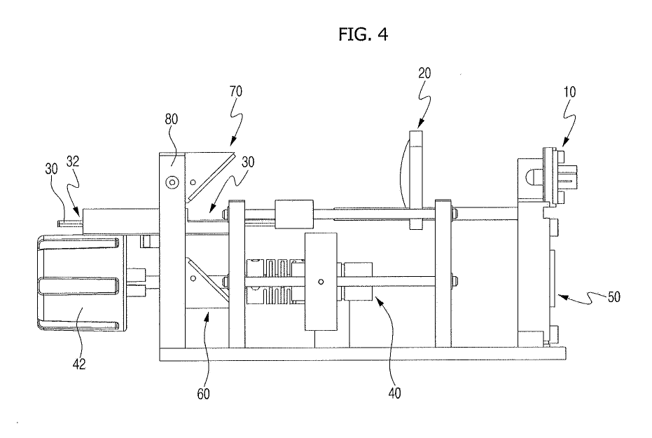

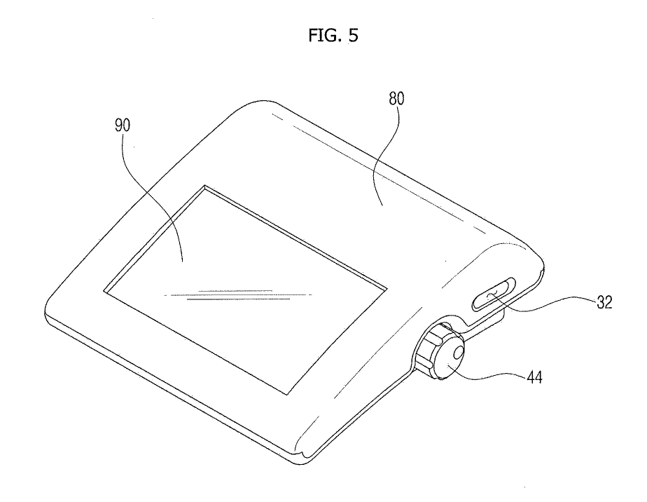

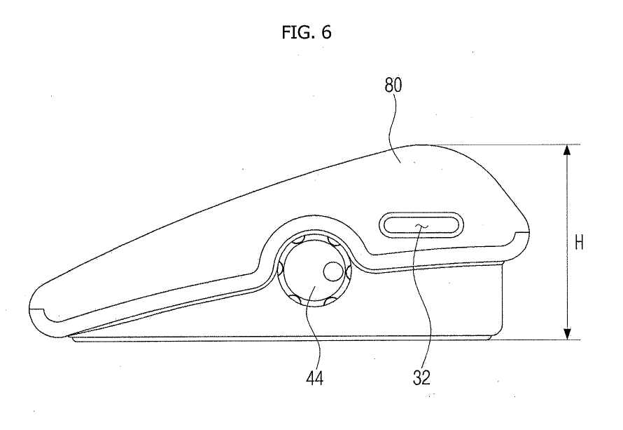

First, a construction of a cell counter according to an exemplary embodiment of the present invention will be described in detail with reference to FIGS. 4 to 6. Here, FIG. 4 is a cross-sectional view of a cell counter according to an exemplary embodiment of the present invention, FIG. 5 is a perspective view of the cell counter according to the exemplary embodiment of the present invention, and FIG. 6 is a side view of the cell counter according to the exemplary embodiment of the present invention.

As illustrated in FIGS. 4 to 6, the inventive cell counter includes a sample slide 30, an object lens 40, a first reflecting mirror 60, and a housing 80.

Here, the sample slide 30 is a component that is provided to accommodate cells, and may be referred to as a micro chip to which a top plate and a bottom plate are coupled to form a cell accommodating unit.

The sample slide 30 is not necessarily limited in connection with its shape and construction if it is configured to accommodate cells. However, it would be advantageous to configure the sample slide 30 to be easily inserted between the first reflecting mirror 60 and a second reflecting mirror 70 through a slide insertion hole 32 in the housing 80.

Meanwhile, the object lens 40 is a component provided to image-form a cell image projected from the sample slide 30, and requires a predetermined working distance within the housing 80 such that a clear cell image can be provided to an image acquisition unit 50.

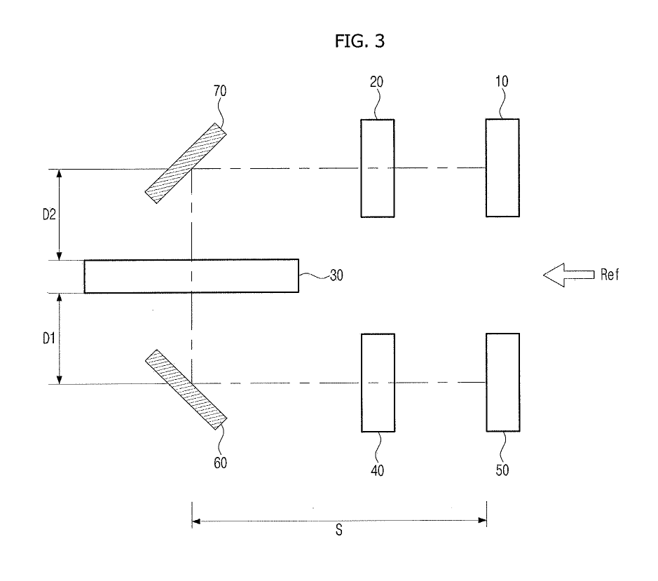

That is, in order to provide a clear image to the image acquisition unit 50, the object lens 40 is arranged in the S distance indicated in FIG. 3 or in a part of the S distance to have a suitable focal length through an object lens operating unit.

If the object lens 40 is arranged in the S distance indicated in FIG. 3 or in a part of the S distance in this manner, the operation of the object lens 40 does not affect the height of the housing 80 as described below.

Meanwhile, the first reflecting mirror 60 is a component configured to change the projection direction of a cell image projected to the object lens 40 from the sample slide 30 in order to allow the object lens 40 to be arranged in the S distance indicated in FIG. 3 or in a part of the S distance.

If the first reflecting mirror 60 does not exist, the projection direction of the cell image will be directed to the upper side or lower side of the sample slide 30 due to the straight forwardness of light, and the object lens 40 will be provided in the upper side or lower side of the sample slide 30 rather than in the S distance indicated in FIG. 3 or in a part of the S distance, thereby causing many limitations in determining the height of the housing 80.

That is, because the first reflecting mirror 60 is provided between the sample slide 30 and the object lens 40, a cell image initiating from the sample slide 30 may be projected in a direction other than toward the upper side or lower side, and the object lens 40 configured to image-form the projected cell image is not necessarily positioned in the upper side nor lower side of the sample slide 30.

Accordingly, as described above, the object lens 40 may be positioned in the S distance indicated in FIG. 3 or in a part of the S distance. Consequently, designing the housing 80 will not be limited due to the space in which the object lens 40 is arranged.

More specifically, the sample slide 30 inserted into the housing 80 is disposed on a virtual plane within the housing 80, and the first reflecting mirror 60 and the object lens 40 may be mounted on another virtual plane within the housing 80 which is parallel to the virtual plane where the sample slide 30 is arranged. At this time, the another virtual plane within the housing 80 is arranged within the housing 80 may be a floor surface of the housing 80 that is in contact with a virtual plane where the cell counter according to the present exemplary embodiment is installed or laid.

That is, by changing the projection direction of the cell image projected from the sample slide 30 in the direction of the height of the housing 80 to the transversal or longitudinal direction of the floor surface of the housing 80 through the first reflecting mirror 60 the object lens 40 may be arranged in the transversal or longitudinal direction of the housing 80. As such, the height of the housing 80 may not be limited by the object lens 40.

If the height of the housing 80 is not limited by a component mounted within the housing 80 in this manner, the housing 80 may be configured to have a height of 50 mm to 150 mm that makes the housing 80 suitable for a user to place the housing 80 on a desk to use it. In addition, when another device including such a cell counter, for example, a cell cultivation device is manufactured, the housing 80 may be configured to have a height of 50 mm to 150 that allows the housing 80 to be easily mounted in the cell cultivation device.

Meanwhile, the housing 80 is a component that is provided to accommodate almost all of other components, and there is no limitation in shape or construction for the housing 80.

However, in a case where the user places the housing 80 on a desk to use it, it may be advantageous to provide the housing 80 with a display unit 90 as described below for the user's convenience, or to fabricate the housing 80 as illustrated in FIG. 5 by taking the user's esthetic sense into consideration. However, in a case where the cell counter of the present exemplary embodiment is included in another device, the housing 80 may be fabricated without providing the display unit 90 or considering the esthetic sense for the external appearance of the housing 80.

At this time, because the height of the housing 80 may is restrained due to the arrangement of the object lens 40 by changing the projection direction of the cell image directed from the sample slide 30 to the object lens 40 through the first reflecting mirror 60 as described above, the esthetic sense may be further enhanced by reducing the height of the housing 80.

Furthermore, the housing 80 may be provided with a display unit 90 on the outer top side thereof to display a result obtained by acquiring a magnified cell image from the object lens 40 and calculating the magnified cell image, i.e. cell information.

At this time, the display unit 90 may be configured in various shapes and constructions if it is capable of displaying cell information. That is, the display unit 90 may merely display cell information like an ordinary monitor or a screen, and may be configured such that cell information can be displayed in other preset types using fingers or a pointing input unit, such as a stylus pen.

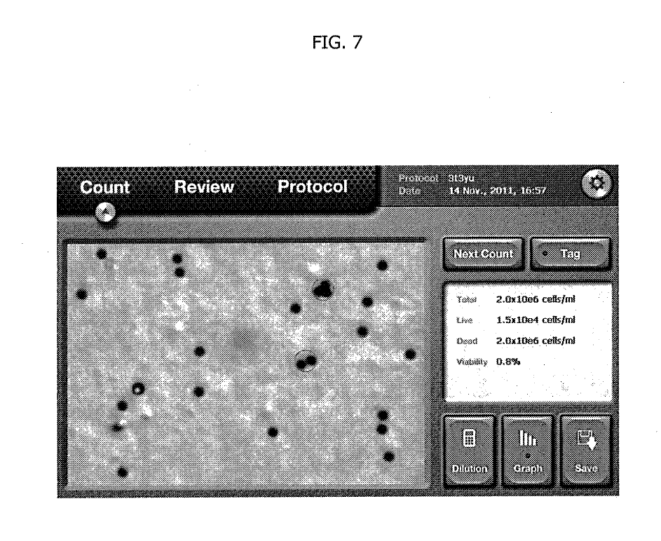

However, among these constructions, it is natural that the user would feel more comfortable if the display unit 90 displays cell information in various types (for example, as in the screen illustrated in FIG. 7) when the pointing input unit (not illustrated) is touched to the display unit 90 like the latter construction.

In a case where the display unit 90 is configured like a so-called touch screen in this manner, it would be more advantageous to configure the top side of the housing 80 to be inclined such that the front part is lower than the rear part so as to make the user's wrists feel comfortable when using the pointing input unit (not illustrated). In that event, the inclined top side of the housing 80 is also effective in removing a blind spot when the user watches the display unit 90.

Meanwhile, the housing 80 may be provided with a slide insertion hole 32 and a focus adjusting knob 42 on a lateral side as illustrated in FIG. 5.

The slide insertion hole 32 is provided so as to allow the sample slide 30 to be inserted into the inside from the outside, and the focus adjusting knob 42 is provided to be used when it is required to manually adjust the focal distance of the object lens 40.

The slide insertion hole 32 and the focus adjusting knob 42 are not necessarily provided on the lateral side of the housing 80, and the positions thereof may be variously changed in consideration of the user's esthetic sense.

As illustrated in FIGS. 4 to 6, the cell counter according to the present exemplary embodiment may further include a light source 10, a collimating lens 20, and a second reflecting mirror 70 beyond the sample slide 30, the object lens 40, the first reflecting mirror 60, and the housing 80 as described above.

The light source 10 is a component configured to provide light toward the sample slide 30 considering that the housing 80 may be formed from an opaque material, and the cell image may not be formed as no light is introduced into the housing 80 from the outside.

The light source 10 may be configured by using any component if it provides light toward the sample slide 30. However, since the light may be concentrated into one point according to the type of the light, a collimating lens 20 as described later may be provided between the light source 10 and the sample slide 30.

The collimating lens 20 is a component provided to adjust the light supplied from the light source 10, and is configured to adjust the intensity and illumination direction of the light according to a calculation method of a calculation unit (not illustrated).

For example, when it is desired to confirm how many cells have been multiplied using the inventive cell counter, a difference in contrast value of cell images may be checked to determine how many cells have been multiplied. In such a case, it may be required to adjust the light provided from the light source 10 so that the difference in contrast value of the cell images can be confirmed well, and the collimating lens 20 is needed for this purpose.

As another example, if the light is dispersed over the sample slide 30, the cell image may not be properly image-formed by the object lens 40. Accordingly, it may be necessary to adjust the light supplied from the light source 10 to be evenly transmitted to the sample slide 30, and the collimating lens 20 is needed for this purpose.

However, when the collimating lens 20 is included to adjust the light supplied from the light source 10 as described above, the height of the housing 80 may be limited depending on how the collimating lens 20 is arranged.

However, the limitation of the height of the housing 80 according to the position of the collimating lens 20 may be solved by changing the direction of the light directed toward the sample slide 30 through the second reflecting mirror 70 as described below.

That is, in order to prevent the height of the housing 80 from being limited by the collimating lens 20, the second reflecting mirror 70 is provided between the sample slide 30 and the light source 10 to change the direction of the light adjusted through the collimating lens 20 to be directed toward the sample slide 30.

More specifically, the second reflecting mirror 70 may be provided in a side opposite to the first reflecting mirror 60 with reference to the sample slide 30. Through this, the collimating lens 20 may be arranged on a virtual plane within the housing 80 which is parallel to a virtual plane where the object lens 40 is arranged within the housing 80.

That is, because the direction of the light is changed due to the second reflecting mirror 70, the collimating lens 20 may be arranged in the transversal or longitudinal direction of housing 80 within the housing 80 regardless of the height of the housing 80, by which there will be no influence in configuring the housing 80 to have a height of 50 mm to 150 mm.

Meanwhile, the cell counter of the present exemplary embodiment may include an image acquisition unit 50 configured to acquire a magnified cell image from the object lens 40 like a camera or a photodiode, and a calculation unit (not illustrated) configured to calculate cell information desired by the user through the cell image acquired through the image acquisition unit 50.

At this time, it is also required that the image acquisition unit 50 and the calculation unit (not illustrated) do not limit the height of the housing 80. In order to solve this problem, the image acquisition unit 50 and the calculation unit (not illustrated) may be arranged on the virtual plane where the first reflecting mirror 60 and the object lens 40 are arranged within the housing 80, i.e. the floor surface within the housing 80.

If the image acquisition unit 50 and the calculation unit (not illustrated) are arranged in this manner, there will be no problem in configuring the housing 80 to have a height of 50 mm to 150 mm as described above.

The cell counter according to an exemplary embodiment of the present invention may include a storage unit (not illustrated) configured to store all the information on cells calculated through the calculation unit (not illustrated).

In that event, the storage unit (not illustrated) may be a memory configured integrally with the calculation unit (not illustrated) like a hard disc, or a memory configured to be inserted into or extracted from the housing 80 like a USB memory. In either case, the storage unit shall not limit the height of the housing 80.

Although the storage unit (not illustrated) may store all the information on cells calculated through the calculation unit (not illustrated) as described above, the storage unit may also separately store only the information on cells displayed on the display unit 90 according to the user's input.

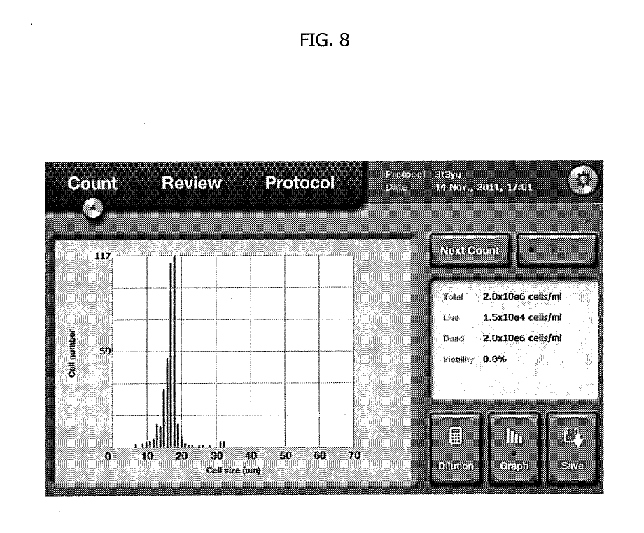

Next, the operation of the inventive cell counter will be described in detail with reference to FIGS. 3, 7 and 8. Here, FIG. 3 is a schematic view for describing the inventive cell counter, and FIGS. 7 and 8 are photographs illustrating examples of displaying information on cells through the display unit included in the inventive cell counter.

First, when the user accommodates cells having information to be obtained into the sample slide 30, and then inserts the sample slide 30 into slide insertion hole 32 provided on a lateral side of the housing 80, the sample slide 30 is positioned between the first reflecting mirror 60 and the second reflecting mirror 70 as illustrated in FIG. 3.

Then, when light is provided from the light source 10, the light arrives at the collimating lens 20 arranged in a direction parallel to the direction of inserting the sample slide 30 (in FIG. 3, in the direction indicated Ref arrow), and the collimating lens 20 adjusts the arriving light to be suitable for an intended purpose.

The light adjusted in this manner should be directed toward the sample slide 30, in which the direction of the light is changed through the second reflecting mirror 70 to be directed toward the sample slide 30, so that an image of cells accommodated in the sample slide 30 starts to be projected.

The cell image projected in this manner is not directly image-formed by the object lens 40 but suffers from a change in direction through the first reflecting mirror 60 and then is image-formed the image acquisition unit 50 by the object lens 40. As the cell image can be image-formed through the object lens 40 after suffering from a change in direction through the first reflecting mirror 60, the object lens 40 can be arranged parallel to the direction where the sample slide 30 has been inserted (in FIG. 3, in the direction indicated by Ref arrow).

Thereafter, the cell image image-formed by the object lens 40 is acquired through the image acquisition unit 50, and the acquired cell image is calculated through the calculation unit (not illustrated) to obtain desired information.

The cell information calculated in this manner is displayed through the display unit 90 as illustrated in FIG. 7, in which when the pointing input unit is touched to the display unit 90 according to the user's input, the cell information is displayed in another preset type as in FIG. 8.

At this time, the storage unit (not illustrated) may store all the cell information calculated by the calculation unit (not illustrated), or may store only the cell information displayed on the display unit 90 according to the user's input.

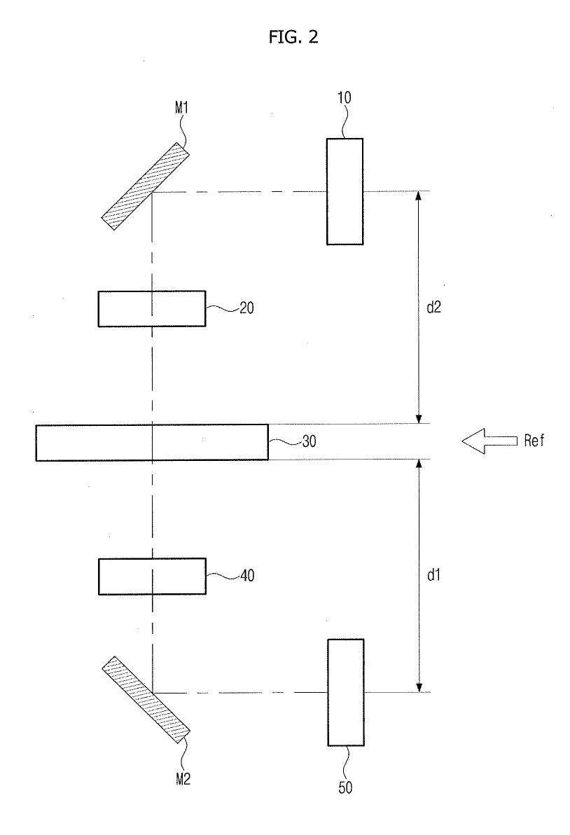

As described above, there is no component related to the direction of height of the housing 80 anywhere in the process of operating the inventive cell counter, which will be described in more detail below. For this detailed description, the conventional construction illustrated in FIG. 2 described in the background of the invention above and the construction illustrated in FIG. 3 will be described in comparison prior to the detailed description.

First, with the conventional cell counter as illustrated in FIG. 2, the height of the housing cannot help but being naturally limited by the positions of the object lens 40 and the collimating lens 20 because the object lens 40 and the collimating lens 20 are respectively arranged in d1 and d2 where the height of the housing 80 is determined.

However, with the inventive cell counter illustrated in FIG. 3, because the object lens 40 and the collimating lens 20 are not arranged in D1 and D2 where the height of the housing 80 is determined, the height of the housing 80 is not affected by the positions of the object lens 40 and the collimating lens 20 at all, and D1 and D2 that determine the height of the housing 80 of the inventive cell counter are substantially smaller than d1 and d2 that determine the height of the housing of the conventional cell counter.

That is, the inventive cell counter does not include any technical component that influences the height of the housing 80. In view of this, it is believed that the problems to be solved by the present invention can be fully solved.

Finally, the inventive method of manufacturing a cell counter according to another exemplary embodiment of the present invention will be described in detail while summarizing the above description for the inventive cell counter.

First, the inventive method of manufacturing a cell counter arranges the first reflecting mirror 60 configured to change the direction of projecting a cell image for the cells accommodated in the sample slide 30 from the sample slide 30 to the object lens 40 configured to image-form the cell image, so that the height of the housing 80 is not affected by the operating distance where the object lens 40 is operated for adjusting the focus thereof when the cell image is image-formed.

In addition, the inventive, method of manufacturing a cell counter additionally arranges the light source 10 configured to provide light toward the sample slide 30 and the collimating lens 20 configured to adjust the light provided from the light source 10 on a virtual plane within the housing 80 which is parallel to a plane where the first reflecting mirror 60 and object lens 40 are arranged within the housing 80, and arranges the second reflecting mirror 70 in a side opposite to the first reflecting mirror 60 with reference to the sample slide 30. As a result, the inventive cell counter is manufactured in such a manner that the height of the housing 80 is not affected by the distance from the light source 10 to the collimating lens 20.

Furthermore, the inventive cell counter may be manufactured in such a manner that the image acquisition unit 50 configured to acquire the cell image image-formed by the object lens 40 and the calculation unit (not illustrated) configured to calculate cell information from the cell image acquired through the image acquisition unit 50 are additionally arranged on the virtual plane where the first reflecting mirror 60 and object lens 40 are arranged within the housing 80.

According to the inventive method of manufacturing a cell counter, the cell counter can be manufactured in such a manner that the height of the housing 80 is 50 mm to 150 mm, which makes it possible to consider the user's convenience and esthetic sense, and is advantageous in manufacturing other devices including the inventive cell counter.

In addition, according to the inventive method of manufacturing a cell counter, the object lens 40 and the collimating lens 20 are arranged in the transversal or longitudinal direction which is irrelevant to the height of housing 80. Therefore, it is possible to remove a difficulty to adjust again the focuses of the object lens 40 and the collimating lens 20 once the focuses were adjusted even when the cell counter has been used for a long period.

It is apparent to an ordinarily skilled in this art that although several specific exemplary embodiments of the present invention have been described and illustrated, the present invention is not limited thereto and can be variously changed and modified within the idea and scope of the present invention. Therefore, such changes or modifications shall not individually be understood from the technical idea and viewpoint of the present invention, and shall be construed as belonging to the scope of the present invention which can be determined based on the claims.

What is claimed is:

1. A cell counter comprising:
a sample slide configured to accommodate cells;
a housing configured that the sample slide is inserted into an inside of the housing from an outside of the housing;
an object lens configured to be mounted within the housing, and to image-form a cell image for the cells projected from the sample slide;
an image acquisition unit configured to be mounted within the housing together with the object lens, and to acquire the cell image image-formed by the object lens; and
a first reflecting mirror provided between the sample slide and the object lens within the housing, and configured to change a projection direction of the cell image projected from the sample slide to the object lens.

2. The cell counter of claim 1, wherein first reflecting mirror changes the projection direction of the object lens projected to the object lens in such a manner that the height of the housing is not limited by the arrangement of the object lens and the image acquisition unit.

3. The cell counter of claim 2, wherein the object lens and the image acquisition unit are arranged on a virtual plane that is parallel to a virtual plane where the sample slide is arranged after being inserted into the inside of the housing.

4. The cell counter of claim 2, wherein the height of the housing is 50 mm to 150 mm.

5. The cell counter of claim 1, further comprising:
a light source configured to provide light toward the sample slide;
a collimating lens configured to adjust the light provided from the light source; and
a second reflecting mirror provided in a side opposite to the first reflecting mirror with reference to the sample slide to change the direction in which the light adjusted through the collimating lens is directed.

6. The cell counter of claim 5, wherein the second reflecting mirror changes the direction of the light directed toward the sample slide in such a manner that the height of the housing is not limited by the arrangement of the light source and the collimating lens.

7. The cell counter of claim 6, wherein the object lens and the image acquisition unit arranged within the housing on a virtual plane which is parallel to a virtual plane where the sample slide is arranged after being inserted into the inside of the housing, and the light source and the collimating lens are arranged within the housing on the virtual plane which is parallel to the virtual plane where the object lens and the image acquisition unit are arranged.

8. The cell counter of claim 6, wherein the height of the housing is 50 mm to 150 mm.

9. The cell counter of claim 1, further comprising:
a calculation unit configured to calculate cell information on the cells from the cell image acquired through the image acquisition unit; and
a display unit configured to display the cell information calculated through the calculation unit.

10. The cell counter of claim 9, wherein the display unit is configured to display the cell information in a preset type when a pointing input unit is touched to the display unit.

11. The cell counter of claim 10, wherein the display unit is arranged on the top side of the housing.

12. The cell counter of claim 10, further comprising:
a storage unit configured to store all the cell information calculated through the calculation unit, and to separately store the cell information displayed on the display unit.

13. A cell counter comprising:
a housing provided with a display unit on an outer top side thereof;
a sample slide configured to accommodate cells and to be inserted into an inside of the housing from an outside of the housing in a direction parallel to an internal bottom side of the housing through a slide insertion hole provided in a lateral side of the housing;
an object lens mounted in the inside of the housing to image-form a cell image for the cells which is projected from the sample slide, the object lens being arranged on the internal bottom side in a transversal or longitudinal direction of the housing in such a manner that an operation distance in which the object lens is operated to adjust a focus thereof when the cell image is image-formed does not restrain a height of the housing; and
a first reflecting mirror provided between the sample slide and the object lens within the housing, and configured to change a direction of projecting the cell image so that the cell image can be projected from the sample slide to the object lens.

14. The cell counter of claim 13, further comprising:
a light source configured to provide light toward the sample slide;
a collimating lens mounted within the inside of the housing to adjust the light provided from the light source in such a manner that a contrast value of the cell image projected to the object lens can be adjusted, the collimating lens being arranged parallel to a virtual plane where the object lens is arranged in the transversal or longitudinal direction of the housing in such a manner that the distance from the light source does not restrain the height of the housing; and
a second reflecting mirror provided in a side opposite to the first reflecting mirror with reference to the sample slide to change the direction in which the light adjusted through the collimating lens is directed.

15. The cell counter of claim 14, further comprising:
an image acquisition unit configured to acquire the cell image image-formed by the object lens; and
a calculation unit configured to calculate cell information on the cell from the cell image acquired through the image acquisition unit,
wherein the image acquisition unit and the calculation unit are arranged on the virtual plane in the housing where the first reflecting mirror and the object lens are arranged so that the height of the housing can be 50 mm to 150 mm.

16. A method of manufacturing a cell counter comprising:
arranging a first reflecting mirror between a sample slide and an object lens in a housing, the object lens being configured to image-form a cell image for cells accommodated in the sample slide, and the first reflecting mirror being configured to change a direction of projecting the sample image projected to the object lens, wherein the height of housing is not limited by an operating distance where the object lens is operated to adjust the focus thereof when image-forming the cell image.

17. The method of claim 16, further comprising:
arranging a light source configured to provide light toward the sample slide and a collimating lens configured to adjust the light provided from the light source, on a virtual plane within the housing which is parallel to a virtual plane where the first reflecting mirror and the object lens are arranged within the housing, and
arranging a second reflecting mirror in a side opposite to the first reflecting mirror with reference to the sample slide, whereby the height of the housing is not limited by the distance from the light source to the collimating lens.

18. The method of claim 17, further comprising:
arranging an image acquisition unit configured to acquire the image cell image-formed by the object lens and a calculation unit configured to calculate cell information on the cell from the cell image acquired through the image acquisition unit, on the virtual plane where the first reflecting mirror and the object lens are arranged within the housing so that the height of the housing can be 50 mm to 150 mm.
